(19) United States
(12) Patent Application Publication
(10) Pub. No.: US 2025/0053384 A1
(43) Pub. Date: Feb. 13, 2025

(54) METHOD AND DEVICE FOR MULTIPLE EXECUTABLE BINARIES WITH STATIC LINKS

(71) Applicant: MEDIATEK INC., Hsinchu City (TW)

(72) Inventors: Wei-Chun KAO, Hsinchu City (TW); Hsien-Ming TSAI, Hsinchu City (TW); Jing-Yen HUANG, Hsinchu City (TW); Ming-Chun CHENG, Hsinchu City (TW)

(21) Appl. No.: 18/447,522

(22) Filed: Aug. 10, 2023

(51) Int. Cl. G06F 8/30

(52) U.S. Cl. CPC G06F 8/30

(57) ABSTRACT

A method for multiple executable binaries with static links is provided. The method includes a fixed binary generated from non-modified source program file has symbols of functions and variables with fixed addresses; a first modifiable binary generated from modified source program files has symbols of functions and variables with changed addresses; and a first reference table contains the symbols of functions and variables of the first modifiable binary which are referred by the fixed binary; wherein the first modifiable binary refers to the symbols of the fixed binary directly, and the fixed binary refers to the symbols of functions and the variables of the first modifiable binary through the first reference table at runtime.

### BACKGROUND OF THE INVENTION

### Field of the Invention

The present disclosure generally relates to computer operating systems or embedded systems. More specifically, aspects of the present disclosure relate to a method and a device for multiple executable binaries with static links.

### Description of the Related Art

Software development is an iterative process. Source code is expressed in a language, such as “C” or assembly, and is organized into multiple source program files. Each of these files is processed into a corresponding executable binary file by a compiler, an assembler and a linker.

Referring to FIG. 1, a software development system 100 is depicted. As described above, source program files 110 are source code written by a programmer. The source program files 110 may represent a plurality of source program files. The source program files 110 are compiled by a compiler with an assembler into object files 120. An object file is a file containing object code which is not only machine code but also additional symbol information for the linker/binder. As described above, all related object files 120 are linked together by the linker to generate an executable binary file 130. The executable binary file 130 can be loaded into the memories and executed by the CPU 140.

However, due to debugging or new function updates, some source program files may require modifications. These modified source program files (new) 112 must be re-compiled/re-assembled into the object files (new) 122, and all object files (new) 122 are re-linked to generate an executable binary file (new) 132. The new executable binary file 132 is different from the original executable binary file 130.

In such cases, even for a small, local modification, the entirety of the binary file generated in the procedure described above needs to be replaced.

Moreover, when the process of re-linking is performed by the linker, as a result of the object relocation, the information pertaining to the location to which the object is relocated (symbol information) is newly generated. Generally, the new symbol information obtained from the relocation and re-linking is different from the symbol information of the original executable binary file. Accordingly, even though a local modification is performed, the entirety of the executable binary file is changed from the original executable binary file.

For the software flexibility, some functions and program variables in source program files are not allowed to be modified in the original executable binary file. Other modifiable source program files are expected to be separated from the original executable binary file. In computer science, two types of software libraries, static library and dynamic library, have been proposed to improve software flexibility.

The static library is an archiving library file containing object codes and can be statically appended into a target application by a linker to generate a stand-alone executable binary at building time. However, the object codes contained in the static library are not only machine codes but also additional symbol information for the linker/binder. It is not optimized as an executable binary file for final release.

On the other hand, the dynamic library is a standalone executable library file and can be dynamically bound/shared to the target executable application at runtime. Although the dynamic library is a standalone executable binary file, the dynamic library needs to be dynamically loaded into an address space when the target application launches at runtime. For embedded systems, supporting the loading, function getting, and the close of dynamic library may increase the system complexity and cost and decrease the system performance (e.g., application launch time).

Therefore, a method and a device for multiple executable binaries with static links can improve the software flexibility.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide method and a device for multiple executable binaries with static links to improve the software flexibility.

In an exemplary embodiment, a method for multiple executable binaries with static links is provided. The method includes a fixed binary generated from non-modified source program file has symbols of functions and variables with fixed addresses. The method includes a first modifiable binary generated from modified source program files has symbols of functions and variables with changed addresses. The method includes a first reference table contains the symbols of functions and variables of the first modifiable binary which are referred by the fixed binary. The first modifiable binary refers to the symbols of the fixed binary directly, and the fixed binary refers to the symbols of functions and the variables of the first modifiable binary through the first reference table at runtime.

In some embodiments, the method includes a second modifiable binary generated from the modified source program files has symbols of functions and variables with second changed addresses. The method includes a second reference table contains the symbols of functions and the variables of the second modifiable binary which are referred by the fixed binary. The second modifiable binary refers to the symbols of the fixed binary directly, and the fixed binary refers to the symbols of functions and the variables of the second modifiable binary through the second reference table at runtime.

In some embodiments, the fixed binary is generated from the non-modified source program files with an undefined symbol file.

In some embodiments, the first modifiable binary is generated from the modified source program files with an extra symbol file.

In some embodiments, the undefined symbol file comprises a symbol list which records which symbols are defined in the fixed binary but only referred to by the first modifiable binary, wherein when the fixed binary is statically linked, the undefined symbol file is used to avoid garbage collection.

In some embodiments, the extra symbol file comprises a symbol list which records which symbols are defined in the fixed binary but referred to by the first modifiable binary, wherein when the modifiable binary is statically linked, the extra symbol file is used to reduce a linking time to avoid all symbols of the fixed binary are provided.

In some embodiments, the fixed binary and the first modifiable binary are in an executable format.

In some embodiments, the first reference table is included in a header file.

In some embodiments, the first reference table is different from the second reference table.

In an exemplary embodiment, a method for multiple executable binaries with static links to generate a fixed binary at build time is provided. The method includes compiling non-modified source program files including a header file containing a reference table to generate object files. The method includes linking statically the generated object files with an undefined symbol file to generate the fixed binary. The reference table contains symbols of functions and variables of a modifiable binary which are referred by the fixed binary, and the undefined symbol file comprises a symbol list which records which symbols are defined in the fixed binary but only referred to by the modifiable binary. When the fixed binary is statically linked, the undefined symbol file is used to avoid garbage collection.

In an exemplary embodiment, a method for multiple executable binaries with static links to generate a modifiable binary at build time is provided. The method includes compiling modified source program files including a header file containing a reference table to generate object files. The method includes linking statically the generated object files with an extra symbol file to generate the modifiable binary. The reference table contains symbols of functions and variables of the modifiable binary which are referred by a fixed binary, and the extra symbol file comprises a symbol list which records which symbols are defined in the fixed binary but referred to by the modifiable binary. When the modifiable binary is statically linked, the extra symbol file is used to reduce a linking time to avoid all symbols of the fixed binary are provided.

In an exemplary embodiment, a device for executing multiple executable binaries with static links at runtime is provided. The device comprises one or more processors; one storage, one or more memories a host bus. The storage stores a fixed binary, a first modifiable binary and a first reference table. The one or more memories download the fixed binary, the first modifiable binary and the first reference table from the storage. The host bus is coupled to the one or more processors, the storage and the one or more memories. The fixed binary generated from non-modified source program file has symbols of functions and variables with fixed addresses. The first modifiable binary generated from modified source program files has symbols of functions and variables with changed addresses. The first reference table contains the symbols of functions and variables of the first modifiable binary which are referred by the fixed binary. The first modifiable binary refers to the symbols of the fixed binary directly, and the fixed binary refers to the symbols of functions and the variables of the first modifiable binary through the first reference table.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 compares conventional source code build flows for original files and updated files in the prior art, respectively.

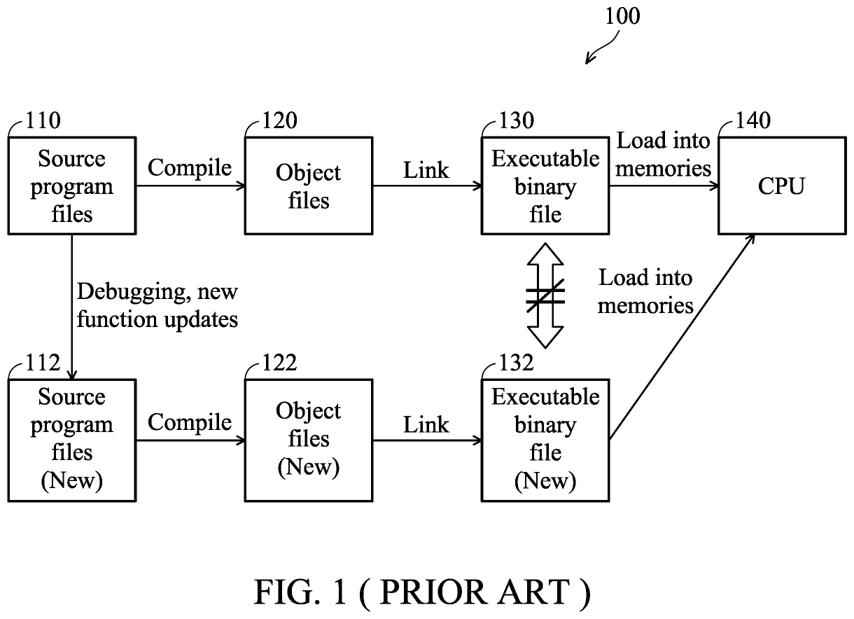

FIG. 2 is a schematic diagram illustrating the fixed binary and the modifiable binary with statical links can be referred by each other through the reference table at runtime according to an embodiment of the disclosure.

FIG. 3 is a schematic process diagram illustrating how to generate a fixed binary and a modifiable binary at building time according to an embodiment of the disclosure.

FIG. 4 is a block diagram illustrating the fixed binary calling the function at the modifiable binary according to an embodiment of the disclosure.

FIG. 5 is a block diagram illustrating the fixed binary referring the variable at the modifiable binary according to an embodiment of the disclosure.

FIG. 6 is a block diagram illustrating one fixed binary executing with multiple modifiable binaries through multiple reference tables according to an embodiment of the disclosure.

FIG. 7 shows a device that may be used to perform one or more of the processes disclosed herein.

### DETAILED DESCRIPTION OF THE INVENTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

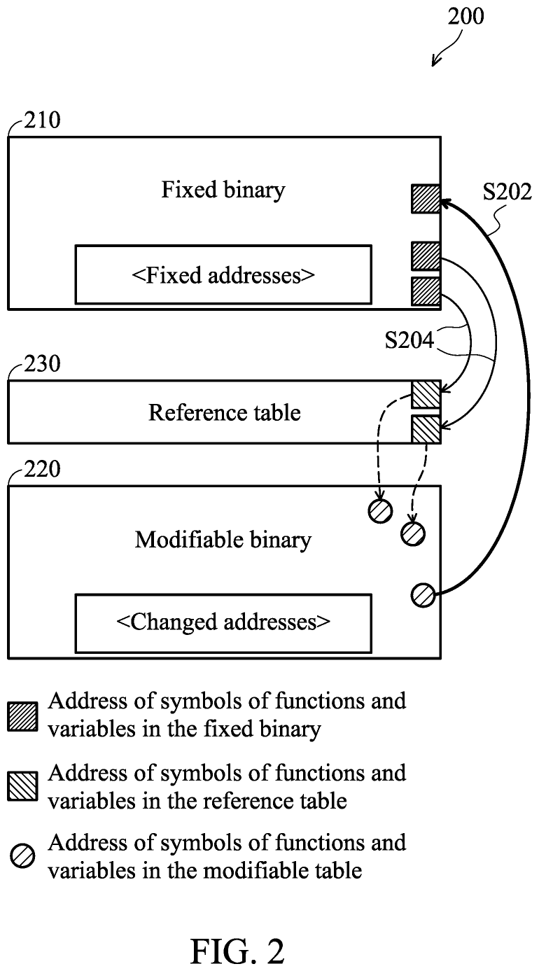

FIG. 2 is a schematic diagram 200 illustrating the fixed binary and the modifiable binary with statical links can be referred by each other through the reference table at runtime according to an embodiment of the disclosure.

In FIG. 2, the fixed binary 210 generated from the non-modified source program files has symbols of functions and variables with fixed addresses, the modifiable binary 220 from the modified source program files has symbols of functions and variables with changed addresses, and the reference table 230 contains the symbols of functions and variables of the modifiable binary 220 which are referred by the fixed binary 210.

Since the addresses of symbols in the fixed binary 210 are not changed (fixed addresses), the modifiable binary 220 can refer to the symbols defined in the fixed binary 210 directly in step S202. On the other hands, since the addresses of symbols in the modifiable binary 220 may be changed (changed addresses), the fixed binary 210 shall refer to the symbols in the modifiable binary 220 through the reference table 230 in step S204.

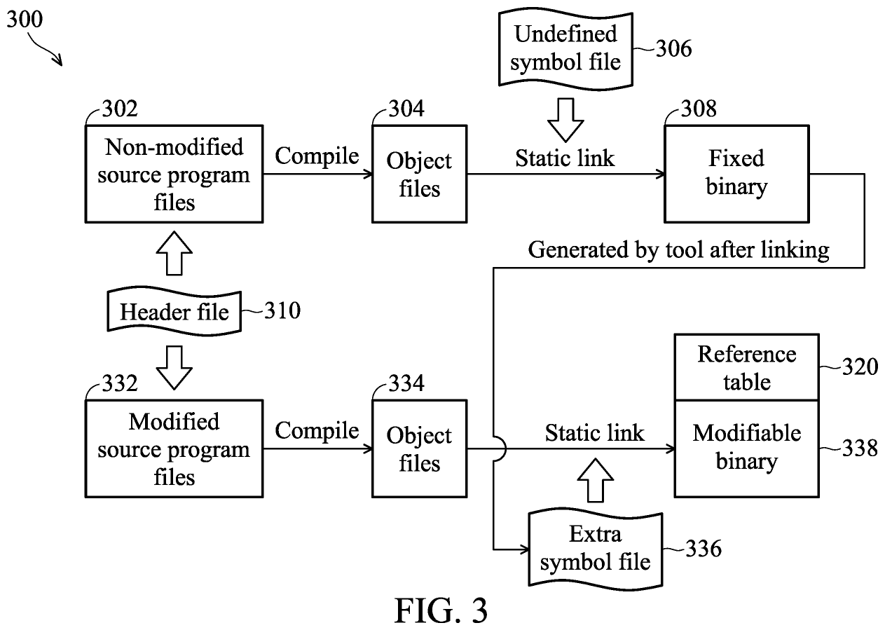

FIG. 3 is a schematic process diagram 300 illustrating how to generate a fixed binary 308 and a modifiable binary 338 at building time according to an embodiment of the disclosure.

Source program files are first divided into non-modified source program files 302 and modified source program files 332, and a header file 310 containing a reference table 320 is generated, wherein the reference table 320 comprises symbols of functions and variables of a modifiable binary 338 which are referred to by a fixed binary 308. In another embodiment, the symbols of functions and variables of the modifiable binary 338 may at least comprise function names, program variables, and so on.

The header file 310 containing the reference table 320 is included in the non-modified source program files 302 and the modified source program files 332, respectively.

The non-modified source program files 302 including the header file 310 are compiled to generate respective object files 304. Then, the fixed binary 308 can be generated by statically linking the object files 304 with an undefined symbol file 306, wherein the undefined symbol file 306 comprises a symbol list which records which symbols are defined in the fixed binary 308 but only referred to by the modifiable binary 338. The undefined symbol file 306 is used by the linker to avoid garbage collection on pre-defined symbols when the fixed binary 308 is statically linked.

The modified source program files 332 including the header file 310 are compiled to generate respective object files 334. Then, the modifiable binary 338 can be generated by statically linking the object files 334 with an extra symbol file 336, wherein the extra symbol file 336 comprises a symbol list which records which symbols are defined in the fixed binary 308 but referred to by the modifiable binary 338. The extra symbol file 336 is used by the linker to reduce the linking time to avoid all symbols of the fixed binary are provided when the modifiable binary 338 is statically linked.

It should be noted that the fixed binary 308 and the modifiable binary 338 respectively generated from the non-modified source program files 302 and the modified source program files 332 are in an executable format.

In another embodiment, the header file 310, the undefined symbol file 322 and the extra symbol file 324 may be generated by tools automatically according to reference relations among the fixed binary 308 and the modifiable binary 338. No human intervention is required in generating the fixed binary 308 and the modifiable binary 338.

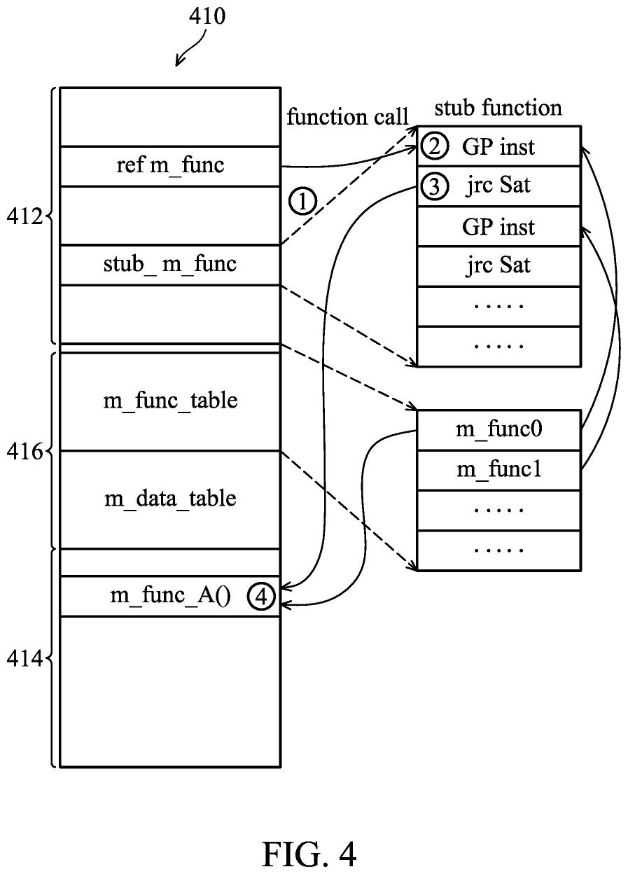

FIG. 4 is a block diagram illustrating the fixed binary calling the function at the modifiable binary according to an embodiment of the disclosure.

When booting with the computer system/device, the fixed binary, the modifiable binary and the reference table are downloaded into the memory space of the computer system/device. As is shown in FIG. 4, the fixed binary 412, the modifiable binary 414 and the reference table 416 are located in the memory segment 410, wherein the reference table 416 records addresses of functions of the modifiable binary 414. It will be understood that embodiments of the present disclosure are not limited to the arrangement of the memory segment 410 as described herein and shown in FIG. 4.

In FIG. 4, the fixed binary calls the modifiable binary m_func_A( ). In step 1, the fixed binary jumps to the stub function. In step 2, the address of m_func_A( ) in the reference table is loaded into a register R1. In step 3, the fixed binary jumps to the address in the register R1, that is, address of m_func_A( ) In step 4, m_func_A( ) is executed.

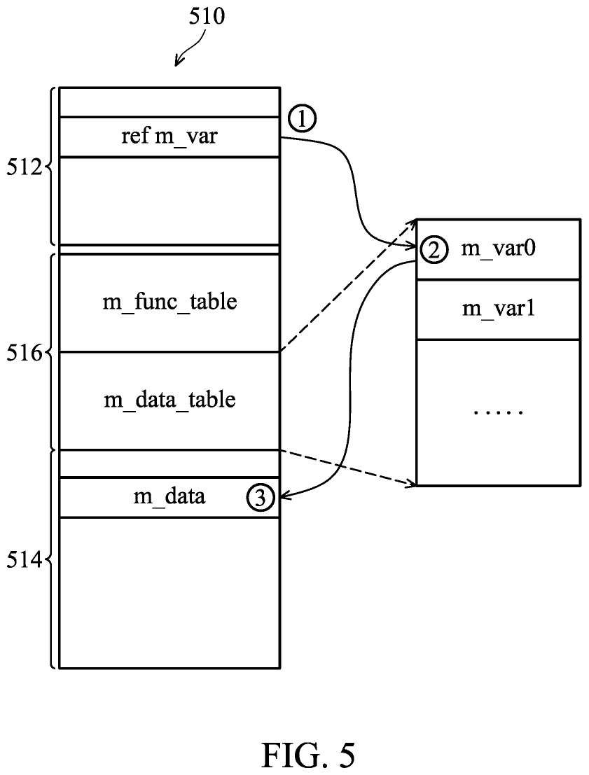

FIG. 5 is a block diagram illustrating the fixed binary referring the variable at the modifiable binary according to an embodiment of the disclosure.

When booting with the computer system/device, the fixed binary, the modifiable binary and the reference table are downloaded into the memory space of the computer system/device. As is shown in FIG. 5, the fixed binary 512, the modifiable binary 514 and the reference table 516 can be located in the memory segment 510, wherein the reference table 516 records addresses of variables of the modifiable binary 514. It will be understood that embodiments of the present disclosure are not limited to the arrangement of the memory segment 510 as described herein and shown in FIG. 5.

In FIG. 5, the fixed binary refers the modifiable binary m_var0. In step 1, the fixed binary loads the address of the modifiable binary m_var0 in the reference table into a register R1. In step 2, the memory content of the address in the register R1 is loaded into a register R2, that is, the value of variable m_var0 is obtained. The process in FIG. 5 describes to read a variable, and the variable writing can be performed in the same way.

It should be noted that the manner of the fixed binary calling the function at the modifiable binary and the manner of the fixed binary referring the variable at the modifiable binary are not used to limit the present disclosure, and those skilled in the art can make appropriate replacements or adjustments according to the embodiments in FIG. 4 and FIG. 5.

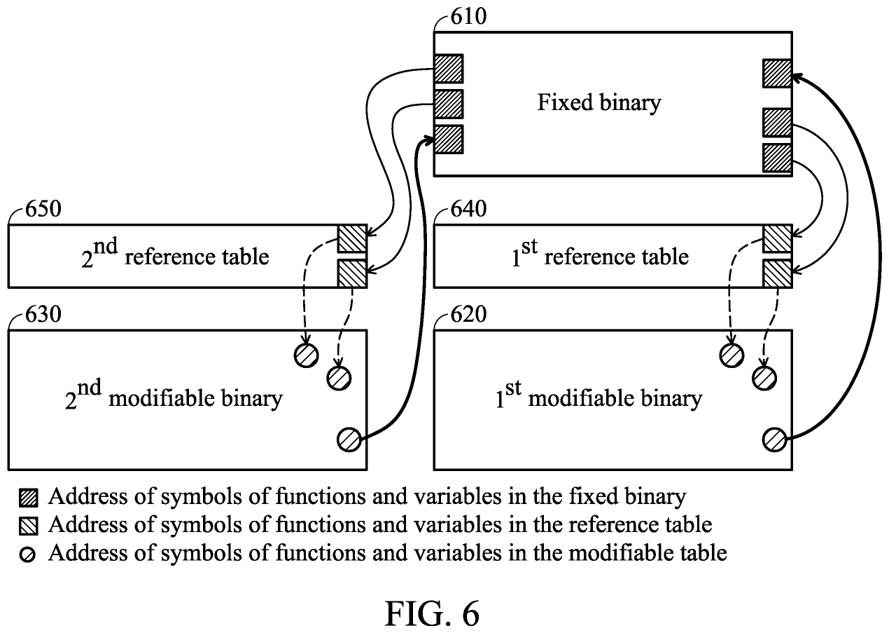

FIG. 6 is a block diagram illustrating one fixed binary executing with multiple modifiable binaries through multiple reference tables according to an embodiment of the disclosure.

In FIG. 6, a fixed binary 610 can refer to the symbols of functions and the variables of a first modifiable binary 620 through a first reference table 640, and also refer to symbols of functions and variables of a second modifiable binary 630 through a second reference table 650 at runtime, wherein the first reference table 640 comprises symbols of functions and variables of the first modifiable binary 620 which are referred to by the fixed binary 610, and the second reference table 650 comprises the symbols of functions and the variables of the second modifiable binary 630 which are referred to by the fixed binary 610. In some embodiments, the first reference table 640 is different from the second reference table 650.

In the above, the embodiment of a device for multiple executable binaries with static links as well as a method for multiple executable binaries with static links has been described in detail.

According to the above-described embodiments, since the symbols of functions and variables of the modifiable binary are recorded in the reference table, the fixed binary can refer to the modifiable binary through the reference table even though a modification is applied to the modifiable binary. Moreover, the fixed binary may further be applied for software reusability, version lock, digital signature certification, and source code confidentiality, while the modifiable binary can be changed to be partial binary patching, or partial over-the-air (OTA) update to reduce the OTA size. In other words, the method and the device for multiple executable binaries with static links may effectively reduce system complexity and cost, and improve the software flexibility for code development, maintenance, and distribution.

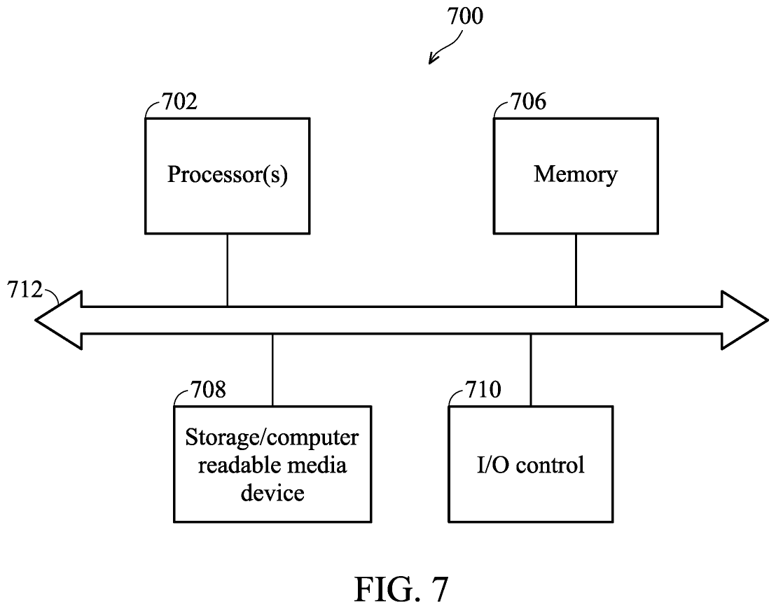

FIG. 7 shows a device 700 that may be used to perform one or more of the processes disclosed herein. It will be appreciated that various alternative computing arrangements, including one or more processors and a memory arrangement configured with program code, would be suitable for hosting the disclosed processes and data structures. The computer code, which implements the disclosed processes, is encoded in a processor executable format and may be stored and provided via a variety of computer-readable storage media or delivery channels such as electronic storage devices, or as application services over a network.

The device 700 includes one or more processors 702, a memory 706, a storage/computer readable media device 708, and an input/output (I/O) control component 710, all coupled to a host bus 712. The device 700 may be implemented with separate components on a circuit board or may be implemented internally within an integrated circuit. When implemented internally within an integrated circuit, the computer system/device is otherwise known as a microcontroller.

The architecture of the computing arrangement depends on implementation requirements as would be recognized by those skilled in the art. The processor(s) 702 may be one or more general-purpose processors, or a combination of one or more general-purpose processors and suitable co-processors, or one or more specialized processors (e.g., RISC, CISC).

The memory 706 typically includes multiple levels of cache memory, and a main memory. The storage/computer readable media device 708 may include local and/or remote persistent storage, such as provided by a FLASH memory, EPROM, or other non-volatile data storage. The storage/computer readable media device 708 may be a non-transitory machine-readable storage medium which can be read or read/write capable. Further, the memory 706 and the storage/computer readable media device 708 may be combined in a single arrangement.

The processor(s) 702 executes the software in the storage/computer readable media device 708 and/or the memory 706, reads instructions/data from and stores instructions/data to the storage/computer readable media device 708 and/or the memory 706, and communicates with external devices through the I/O control component 710. The resource of the computer system/device 700 may be managed by either an operating system (not shown), or a hardware control unit (not shown). Before booting, the fix binary, the reference tables and the modifiable binaries of this disclosure can be stored in the storage 708. After booting, the fix binary, the reference tables and the modifiable binaries of this disclosure can be downloaded from the storage 708 into the memory 706 for the execution by the processor(s) 702.

Those skilled in the art will appreciate that various alternative device, including one or more processors and a memory configured with program code, would be suitable for hosting the processes and data structures of the different disclosed implementations.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for multiple executable binaries with static links, comprising:
a fixed binary generated from non-modified source program file has symbols of functions and variables with fixed addresses;
a first modifiable binary generated from modified source program files has symbols of functions and variables with changed addresses; and
a first reference table contains the symbols of functions and variables of the first modifiable binary which are referred by the fixed binary;
wherein the first modifiable binary refers to the symbols of the fixed binary directly, and the fixed binary refers to the symbols of functions and the variables of the first modifiable binary through the first reference table at runtime.

2. The method for multiple executable binaries with static links as claimed in claim 1, comprising:
a second modifiable binary generated from the modified source program files has symbols of functions and variables with second changed addresses; and
a second reference table contains the symbols of functions and the variables of the second modifiable binary which are referred by the fixed binary;
wherein the second modifiable binary refers to the symbols of the fixed binary directly, and the fixed binary refers to the symbols of functions and the variables of the second modifiable binary through the second reference table at runtime.

3. The method for multiple executable binaries with static links as claimed in claim 1, wherein the fixed binary is generated from the non-modified source program files with an undefined symbol file.

4. The method for multiple executable binaries with static links as claimed in claim 1, wherein the first modifiable binary is generated from the modified source program files with an extra symbol file.

5. The method for multiple executable binaries with static links as claimed in claim 3, wherein the undefined symbol file comprises a symbol list which records which symbols are defined in the fixed binary but only referred to by the first modifiable binary, wherein when the fixed binary is statically linked, the undefined symbol file is used to avoid garbage collection.

6. The method for multiple executable binaries with static links as claimed in claim 4, wherein the extra symbol file comprises a symbol list which records which symbols are defined in the fixed binary but referred to by the first modifiable binary, wherein when the modifiable binary is statically linked, the extra symbol file is used to reduce a linking time to avoid all symbols of the fixed binary are provided.

7. The method for multiple executable binaries with static links as claimed in claim 1, wherein the fixed binary and the first modifiable binary are in an executable format.

8. The method for multiple executable binaries with static links as claimed in claim 1, wherein the first reference table is included in a header file.

9. The method for multiple executable binaries with static links as claimed in claim 2, wherein the first reference table is different from the second reference table.

10. A method for multiple executable binaries with static links to generate a fixed binary at build time, comprising:
compiling non-modified source program files including a header file containing a reference table to generate object files; and
linking statically the generated object files with an undefined symbol file to generate the fixed binary;
wherein the reference table contains symbols of functions and variables of a modifiable binary which are referred by the fixed binary, and the undefined symbol file comprises a symbol list which records which symbols are defined in the fixed binary but only referred to by the modifiable binary;
wherein when the fixed binary is statically linked, the undefined symbol file is used to avoid garbage collection.

11. A method for multiple executable binaries with static links to generate a modifiable binary at build time, comprising:
compiling modified source program files including a header file containing a reference table to generate object files; and
linking statically the generated object files with an extra symbol file to generate the modifiable binary;
wherein the reference table contains symbols of functions and variables of the modifiable binary which are referred by a fixed binary, and the extra symbol file comprises a symbol list which records which symbols are defined in the fixed binary but referred to by the modifiable binary;
wherein when the modifiable binary is statically linked, the extra symbol file is used to reduce a linking time to avoid all symbols of the fixed binary are provided.

12. A device for executing multiple executable binaries with static links at runtime, comprising:
one or more processors;
one storage, storing a fixed binary, a first modifiable binary and a first reference table;
one or more memories, downloading the fixed binary, the first modifiable binary and the first reference table from the storage; and
a host bus, coupled to the one or more processors, the storage and the one or more memories;
wherein
the fixed binary generated from non-modified source program file has symbols of functions and variables with fixed addresses;
the first modifiable binary generated from modified source program files has symbols of functions and variables with changed addresses; and
the first reference table contains the symbols of functions and variables of the first modifiable binary which are referred by the fixed binary;
wherein the first modifiable binary refers to the symbols of the fixed binary directly, and the fixed binary refers to the symbols of functions and the variables of the first modifiable binary through the first reference table.

13. The device for multiple executable binaries with static links as claimed in claim 12, comprising:
a second modifiable binary generated from the modified source program files has symbols of functions and variables with second changed addresses; and
a second reference table contains the symbols of functions and the variables of the second modifiable binary which are referred by the fixed binary;
wherein the second modifiable binary refers to the symbols of the fixed binary directly, and the fixed binary refers to the symbols of functions and the variables of the second modifiable binary through the second reference table at runtime.

14. The device for multiple executable binaries with static links as claimed in claim 12, wherein the fixed binary is generated from the non-modified source program files with an undefined symbol file.

15. The device for multiple executable binaries with static links as claimed in claim 12, wherein the first modifiable binary is generated from the modified source program files with an extra symbol file.

16. The device for multiple executable binaries with static links as claimed in claim 14, wherein the undefined symbol file comprises a symbol list which records which symbols are defined in the fixed binary but only referred to by the first modifiable binary, wherein when the fixed binary is statically linked, the undefined symbol file is used to avoid garbage collection.

17. The device for multiple executable binaries with static links as claimed in claim 15, wherein the extra symbol file comprises a symbol list which records which symbols are defined in the fixed binary but referred to by the first modifiable binary, wherein when the modifiable binary is statically linked, the extra symbol file is used to reduce a linking time to avoid all symbols of the fixed binary are provided.

18. The device for multiple executable binaries with static links as claimed in claim 12, wherein the fixed binary and the first modifiable binary are in an executable format.

19. The device for multiple executable binaries with static links as claimed in claim 12, wherein the first reference table is included in a header file.

20. The device for multiple executable binaries with static links as claimed in claim 13, wherein the first reference table is different from the second reference table.
